(19) United States
(12) Patent Application Publication
(10) Pub. No.: US 2026/0121684 A1
(43) Pub. Date: Apr. 30, 2026

(54) ELECTRONIC DEVICE FOR FILTERING CROSSTALK USING ADAPTIVE FILTER AND OPERATING METHOD THEREOF

(71) Applicant: Samsung Electronics Co., Ltd., Suwon-si (KR)

(72) Inventors: Dongarm Shin, Suwon-si (KR); Seonghwan Cho, Suwon-si (KR)

(73) Assignee: Korea Advanced Institute Of Science And Technology, Daejeon (KR)

(21) Appl. No.: 19/315,337

(22) Filed: Aug. 29, 2025

(30) Foreign Application Priority Data
Oct. 24, 2024 (KR) 10-2024-0147036

(51) Int. Cl. H04B 3/32; H04B 3/487

(52) U.S. Cl. CPC H04B 3/32; H04B 3/487

(57) ABSTRACT

Provided is an electronic device including a first signal line configured to receive a first reception signal, a second signal line configured to receive a second reception signal, a third signal line configured to receive a third reception signal having a correlation with the second reception signal, the third signal line being positioned between the first signal line and the second signal line, a first crosstalk filter connected to the second signal line and configured to output a first compensation signal by applying a pole frequency and a gain coefficient to a second reception signal, and an adaptive filter configured to receive the second reception signal and a first final signal corresponding to the first reception signal, and to adjust the pole frequency and the gain coefficient of the first crosstalk filter based on the second reception signal and the first final signal.

### CROSS-REFERENCE TO RELATED APPLICATION

This application claims priority under 35 U.S.C. § 119 to Korean Patent Application No. 10-2024-0147036, filed on Oct. 24, 2024, in the Korean Intellectual Property Office, the entirety of which is incorporated by reference herein.

### BACKGROUND

When transmitting signals over signal lines between a transmission unit and a reception unit, crosstalk may occur due to coupling capacitance formed between adjacent signal lines.

As the required data transfer rate is steadily increasing with the advancement of technology, the method of placing many signal lines in a small space has recently been used in high-speed interfaces such as chiplets and high bandwidth memory (HBM). In this case, as an interval between signal lines is narrowed, crosstalk due to coupling capacitance may increase. Therefore, when the signal transmitted from the transmission unit is received by the reception unit, it may be difficult to determine the received signal due to the coupling capacitance. There may be various methods for filtering the crosstalk included in the signal received by the reception unit, but the characteristics of the circuit may change according to environmental changes such as process, voltage, temperature, and the like. Due to a change in characteristics of a circuit according to an environmental change, there may be a problem that filtering of crosstalk becomes inaccurate.

### SUMMARY

Some implementations according to the present disclosure provide accurate crosstalk filtering despite changes in the characteristics of the circuit.

Some implementations according to the present disclosure provide electronic devices configured to perform crosstalk filtering insensitive to changes in circuit characteristics based on an adaptive filter, and operating methods of the electronic devices.

According to some implementations, there is provided an electronic device including a first signal line configured to transfer a first transmission signal output from a transmission unit, a second signal line configured to transfer a second transmission signal output from the transmission unit, a third signal line configured to transfer a third transmission signal, wherein the third transmission signal is output from the transmission unit, and wherein the third signal line is positioned between the first signal line and the second signal line, a first crosstalk filter connected to the second signal line and configured to output a first compensation signal by applying filtering based on a pole frequency and by applying gain based on a gain coefficient to a second reception signal corresponding to the second transmission signal, and an adaptive filter connected to the second signal line and configured to receive the second reception signal and a first final signal corresponding to the first transmission signal, wherein the adaptive filter is configured to adjust the pole frequency and the gain coefficient of the first crosstalk filter based on the second reception signal and the first final signal; and a subtractor circuit configured to filter crosstalk included in the first final signal by subtracting the first compensation signal from the first final signal.

According to some implementations, there is provided an operating method of an electronic device, the operating method including receiving a first signal via a first signal line, receiving a third signal via a third signal line located between the first signal line and a second signal line, and receiving a second signal via the second signal line, outputting a first final signal corresponding to the first signal, adjusting a pole frequency and a gain coefficient based on the second signal and the first final signal, to obtain an adjusted pole frequency and an adjusted gain coefficient, outputting a first compensation signal by applying (i) filtering based on the adjusted pole frequency and (ii) gain based on the adjusted gain coefficient, and filtering crosstalk included in a signal received through the first signal line based on the first compensation signal, wherein the first signal line, and the third signal line are directly adjacent, the third signal line and the second signal line are directly adjacent, the first signal may be a data signal including data information, and the second signal and the third signal may be clock signals having a correlation with one another.

According to some implementations, there is provided an electronic device including a plurality of signal lines that are consecutive to each other, a plurality of crosstalk filters configured to compensate for crosstalk between the plurality of signal lines by applying filtering based on a pole frequency and gain based on a gain coefficient to signals received over the plurality of signal lines, and an adaptive filter configured to adjust the pole frequency and the gain coefficient of each of the plurality of crosstalk filters, wherein the plurality of signal lines include a first signal line configured to transfer a data signal including data information, a second signal line located between the first signal line and a third signal line and configured to transfer a first clock signal, and the third signal line, wherein the third signal line is configured to transfer a second clock signal that is opposite in phase to the first clock signal, wherein the adaptive filter is connected to the third signal line, and wherein the adaptive filter is configured to adjust the pole frequency based on a final signal generated by filtering crosstalk from the second clock signal and the data signal, and to adjust the gain coefficient based on (i) the adjusted signal to which filtering based on the adjusted pole frequency is applied and (ii) the final signal.

### BRIEF DESCRIPTION OF THE DRAWINGS

FIG. 1 is a block diagram illustrating an example of an electronic device.

FIG. 2 is a diagram illustrating an example of crosstalk between a plurality of signal lines.

FIGS. 3A and 3B are diagrams illustrating examples of crosstalk filtering between a plurality of signal lines.

FIG. 4 is a circuit diagram illustrating an example of a frequency adjustment circuit.

FIG. 5 is a circuit diagram illustrating examples of a gain coefficient adjustment circuit and a subtractor.

FIG. 6A is a diagram illustrating pulse-amplitude modulation (PAM)-4 Eye in a reception unit due to crosstalk, and FIG. 6B is a diagram illustrating PAM-4 Eye in the reception unit after filtering the crosstalk;

FIG. 7A is a diagram showing PAM-4 Eye in a reception unit after crosstalk filtering in a first environment, and FIG. 7B is a diagram showing PAM-4 Eye in the reception unit after crosstalk filtering in a second environment.

FIG. 8 is a diagram illustrating examples of a plurality of signal lines and a plurality of crosstalk filters.

FIG. 9 is a diagram illustrating an example of crosstalk filtering based on signals received through two consecutive signal lines.

FIG. 10 is a diagram illustrating an example of crosstalk filtering based on signals received over two signal lines spaced apart from each other.

FIG. 11 is a diagram illustrating examples of a first transmission signal, a second transmission signal, and a third transmission signal.

FIG. 12A is a diagram illustrating PAM-4 Eye in a reception unit after crosstalk filtering according to the diagram illustrated in FIG. 9, and FIG. 12B is a diagram illustrating PAM-4 Eye in the reception unit after crosstalk filtering according to the diagram illustrated in FIG. 10.

FIG. 13 is a diagram illustrating an example of a third adaptive loop shown in FIG. 10.

FIG. 14 is a diagram illustrating an example of a fourth adaptive loop shown in FIG. 10;

FIG. 15 is a timing diagram of examples of signals associated with clock gating; and

FIG. 16 is a flowchart illustrating an example of an operating method of an electronic device.

### DETAILED DESCRIPTION

In this disclosure, configurations and elements shown in different drawings and given the same reference numerals may be understood to be the same configuration or element.

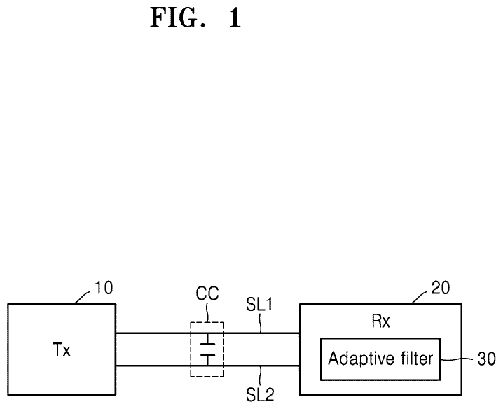

FIG. 1 is a block diagram illustrating an electronic device. Referring to FIG. 1, a transmission unit (Tx) 10 and a reception unit (Rx) 20 may transmit and receive signals through a first signal line SL1 and a second signal line SL2. The reception unit 20 may include an adaptive filter 30. The reception unit 20 may filter crosstalk included in a signal received based on the adaptive filter 30 to more accurately determine the received signal.

The transmission unit 10 may output a signal to be transmitted to the reception unit 20 through the first signal line SL1 and the second signal line SL2. In some implementations, the transmission unit 10 may convert parallel data into serial data and output a signal. In some implementations, the transmission unit 10 may perform a signal equalization operation for compensating for channel loss in addition to a data serialization operation. In some implementations, the signal output from the transmission unit 10 may be referred to as a transmission signal.

In some implementations, the transmission unit 10 may transmit a signal in a pulse-amplitude modulation (PAM)-N (N is an integer greater than or equal to two) scheme (e.g., a PAM-N signaling scheme, a PAM-N decoding scheme, a PAM-N mode, or the like). In this case, the signal may have a voltage level of any one of N different voltage levels according to PAM-N. For example, in the PAM-4 scheme, the transmission unit 10 may transmit a signal having one of four voltage levels. The four voltage levels may correspond to first to fourth logic values (e.g., bit values) (e.g., “00” (=00b), “01” (=01b), “10” (=10b), and “11” (=11b)), respectively. However, transmission schemes are not limited to this. For example, depending on various schemes such as PAM-8 and PAM-16, the signal may have any one of eight or 16 voltage levels. Although it has been described that the transmission unit 10 may transmit a signal in a PAM-N scheme, transmission schemes are not limited thereto, and various signal transmission schemes may be used.

In some implementations, the signal transmitted by the transmission unit 10 may be a single signal as a data signal. However, the scope of this disclosure are not limited to this. For example, in some implementations, signals may include two differential signals having different polarities.

The signal line(s) (e.g., the first signal line SL1 and/or the second signal line SL2) may be an electrical path connecting the transmission unit 10 with the reception unit 20. For example, each signal line may include a trace or coaxial cable of a printed circuit board (PCB). The signal line may deteriorate high-frequency content of high-speed random data due to a skin effect, dielectric loss, and the like. That is, a channel loss may occur in a signal transmitted through the signal line(s) (e.g., SL1 and/or SL2). In addition, the signal line(s) (e.g., SL1 and/or SL2) may cause impedance discontinuity (inconsistency) due to connectors and other physical interfaces between boards and cables. Further, each bit of data that has passed through the signal line(s) (e.g., SL1 and/or SL2) may interfere with the next bit due to channel loss or bandwidth limitations, and inter symbol interference (ISI), which is a phenomenon where neighboring symbols overlap and increase the bit error rate (BER), may occur. Due to phenomena caused by the signal line(s) (e.g., SL1 and/or SL2), a signal (which is referred to as a pass signal in the disclosure) passing through the signal line(s) (e.g., SL1 and/or SL2) may be partially distorted or partially modified compared to the transmission signal. When the transmission signal is a single signal, the pass signal may also be a single signal as a data signal. The data signal may include, for example, a specific logic value (or bit value) such as a command, an address, and data. Referring to FIG. 1, a coupling capacitance (CC) formed between the first signal line SL1 and the second signal line SL2 may be formed.

Therefore, in addition to the above-described channel loss, the reception signal received by the reception unit 20 may include crosstalk due to the coupling capacitance CC. As technology advances, data transmission speed increases, and accordingly, devices including many signal lines within a narrow space (e.g., chiplet, high bandwidth memory (HBM), etc.) are being developed and used. As the distance between the signal lines narrows, the effect of the crosstalk caused by the coupling capacitance CC may increase, and accordingly, it may be difficult to accurately determine the reception signal.

The reception unit 20 may receive a signal through the signal line(s) (e.g., SL1 and/or SL2). The reception unit 20 may decode data based on the reception signal and output decoded data. In some implementations, the reception unit 20 may convert serial data received from the transmission unit 10 into parallel data. In some implementations, the reception unit 20 may perform a signal equalization operation for compensating for channel loss in addition to a data parallelization operation. The reception unit 20 may include an adaptive filter 30 to filter the above-described crosstalk.

The reception unit 20 may effectively remove crosstalk from the reception signal based on the adaptive filter 30 despite changes in circuit characteristics due to environmental changes (e.g., changes in process, voltage, and temperature (PVT)). Furthermore, the reception unit 20 may more effectively eliminate crosstalk by receiving a differential clock signal and adjusting the pole frequency and gain coefficient of the adaptive filter 30 through the differential clock signal.

The reception unit 20 may be implemented as a time-based reception unit, but this is only an example, and the form of the reception unit 20 is not limited thereto.

The reception unit 20 may further include a decoding circuit, a clock generation circuit, and the like. The decoding circuit may output decoded data based on the reception signal.

The decoded data may include a plurality of bit values corresponding to any one of a plurality of symbols in the PAM-N scheme. For example, data decoded in the PAM-4 scheme may include two bits, and the two bits may correspond to any one of “00”, “01”, “10”, and “11”. The clock generation circuit may generate a clock signal.

The clock signal may be a signal that provides a timing required for at least one of the adaptive filter 30 and the decoding circuit to operate. In some implementations, the clock generation circuit may be included in the reception unit 20. However, configurations are not limited thereto, and the clock generation circuit may be arranged outside the reception unit 20. According to some implementations, the clock signal may be transmitted from the transmission unit 10 to the reception unit 20. The transmission unit 10 and the reception unit 20 may be included in a single electronic device.

However, configurations are not limited thereto, and the transmission unit 10 and the reception unit 20 may be separate electronic devices. That is, the devices, methods, and configurations described in this disclosure may be applied to all cases, scenarios, and systems for removing crosstalk that may occur in signal transmission inside one electronic device or through signal lines between a plurality of electronic devices.

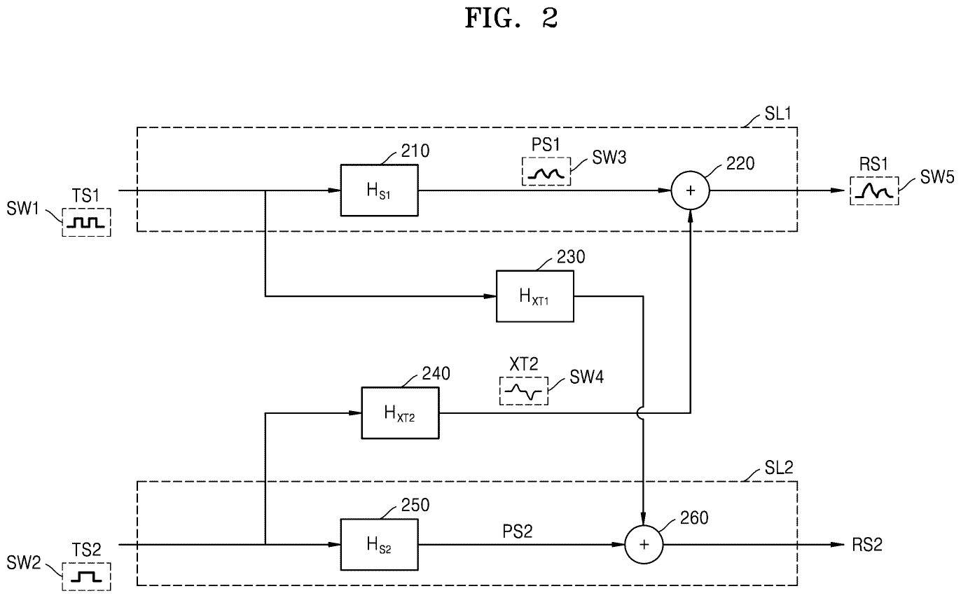

FIG. 2 is a diagram illustrating crosstalk between a plurality of signal lines. Referring to FIG. 2, a first pass signal PS1 may be a signal in which a first transmission signal TS1 is distorted due to a channel loss such as ISI described above.

Here, distortion caused by a channel loss such as ISI may be expressed by a first channel transfer function (H_{S1}) 210. The first reception signal RS1 may be a signal in which the first pass signal PS1 is distorted by crosstalk caused by coupling capacitance formed between the first signal line SL1 and the second signal line SL2 adjacent to the first signal line SL1. Here, distortion caused by crosstalk due to coupling capacitance formed between the first signal line SL1 and the second signal line SL2 adjacent to the first signal line SL1 may be expressed as a second coupling transfer function (H_{TX2}) 240. The second crosstalk signal XT2 by the coupling capacitance and the first pass signal PS1 may be added to become a first reception signal RS1 received by the reception unit. That is, the first reception signal RS1 may be a sum 220 of the first pass signal PS1 in which the first transmission signal TS1 is distorted by the first channel transfer function 210 and a second crosstalk signal XT2 in which a second transmission signal TS2 affects the first signal line SL1 by coupling capacitance. In FIG. 2, the reference numeral “220” appears to indicate an adder for better understanding. That is, the reference numeral “220” is only for indicating that the first reception signal RS1 includes the first pass signal PS1 and the second crosstalk signal XT2, but does not mean a separate configuration or device for adding two signals.

Referring to the first transmission waveform SW1 which is the signal waveform of the first transmission signal TS1, the second transmission waveform SW2 which is the signal waveform of the second transmission signal TS2, the first pass waveform SW3 which is the waveform of the first pass signal PS1, the second crosstalk waveform SW4 which is the signal waveform of the second crosstalk signal XT2, and the first reception waveform SW5 which is the signal waveform of the first reception signal RS1 as shown in FIG. 2, the above description with respect to the first reception signal RS1 may be more clearly understood.

Referring to FIG. 2, a second pass signal PS2 may be a signal in which the second transmission signal TS2 is distorted due to a channel loss such as ISI described above.

Here, distortion caused by a channel loss such as ISI may be expressed by a second channel transfer function (H_{S2}) 250. The second reception signal RS2 may be a signal in which the second pass signal PS2 is distorted by crosstalk caused by coupling capacitance formed between the first signal line SL1 and the second signal line SL2 adjacent to the first signal line SL1. Here, distortion caused by crosstalk due to coupling capacitance formed between the second signal line SL2 and the first signal line SL1 adjacent to the second signal line SL2 may be expressed as a first coupling transfer function (H_{TX1}) 230. The first crosstalk signal XT1 by the coupling capacitance and the second pass signal PS2 may be added to become a second reception signal RS2 received by the reception unit. That is, the second reception signal RS2 may be a sum 220 of the second pass signal PS2 in which the second transmission signal TS2 is distorted by the second channel transfer function 250 and a first crosstalk signal XT1 in which the first transmission signal TS1 affects the second signal line SL2 by coupling capacitance. In FIG. 2, the reference numeral “260” appears to indicate an adder for better understanding. That is, the reference numeral “260” is only for indicating that the second reception signal RS2 includes the second pass signal PS2 and the first crosstalk signal XT1, but does not mean a separate configuration or device for adding two signals.

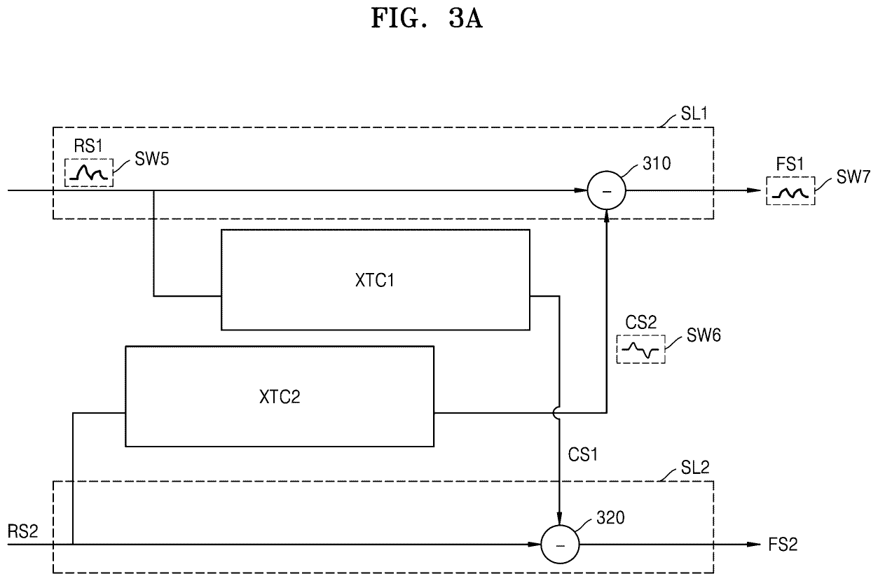

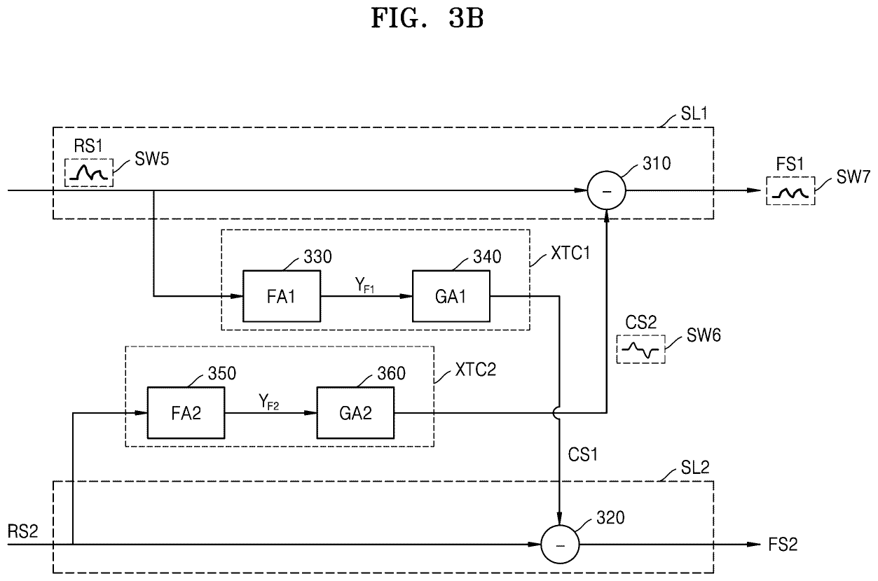

FIGS. 3A and 3B are diagrams illustrating crosstalk filtering between a plurality of signal lines according to some implementations. FIGS. 3A and 3B may be understood with reference to FIG. 2 described above, and FIGS. 3A and 3B will be described below in addition to the description with reference to FIG. 2.

Referring to FIG. 3A, a second crosstalk filter may be included to remove distortion (e.g., distortion due to channel loss and crosstalk signal (XT2 in FIG. 2) included in the first reception signal RS1 described above with reference to FIG. 2.

Here, the second crosstalk filter may be expressed or represented as a second XTC transfer function XTC2. The first signal line SL1 may include a first subtractor 310, and the first subtractor 310 may subtract a second compensation signal CS2 from the first reception signal RS1.

The second compensation signal CS2 may be a signal in which the second reception signal RS2 passes through a second crosstalk filter. The first subtractor 310 may subtract the second compensation signal CS2 from the first reception signal RS1 to output a first final signal FS1. When the first final signal FS1 is expressed by the transfer functions described above, it may be expressed by Equation 1 below.

$$FS 1 ( s ) = TS 1 ( s ) \cdot \{ {H}_{S 1} ( s ) - XTC 2 ( s ) \cdot {H}_{XT} 1 ( s ) \} + T S 2 ( s ) \cdot \{ {H}_{XT 2} ( s ) - XTC 2 ( s ) \cdot {H}_{S 2} ( s ) \} \qquad [ Equation 1 ]$$

In Equation 1, when the condition such as Equation 2 below is satisfied, the influence of the second transmission signal TS2 may be removed from the first final signal FS1.

$${H}_{XT 2} ( s ) = XTC 2 ( s ) \cdot {H}_{S 2} ( s ) \qquad [ Equation 2 ]$$

In Equation 2, H_{XT2}(s) and H_{S2}(s) are transfer functions for coupling capacitance and channel loss, respectively, and thus, if the second XTC transfer function XTC2 is adjusted to satisfy Equation 2, the influence of the second transmission signal TS2 from the first final signal FS1 may be removed or alleviated. That is, by adjusting the second XTC transfer function XTC2, the first final signal FS1 obtained by removing or alleviating crosstalk from the first reception signal RS1 may be generated.

However, when the second XTC transfer function XTC2 is adjusted to satisfy Equation 2, the accuracy of crosstalk filtering may be reduced due to changes in circuit characteristics due to environmental changes (e.g., changes in process, voltage, and temperature (PVT)).

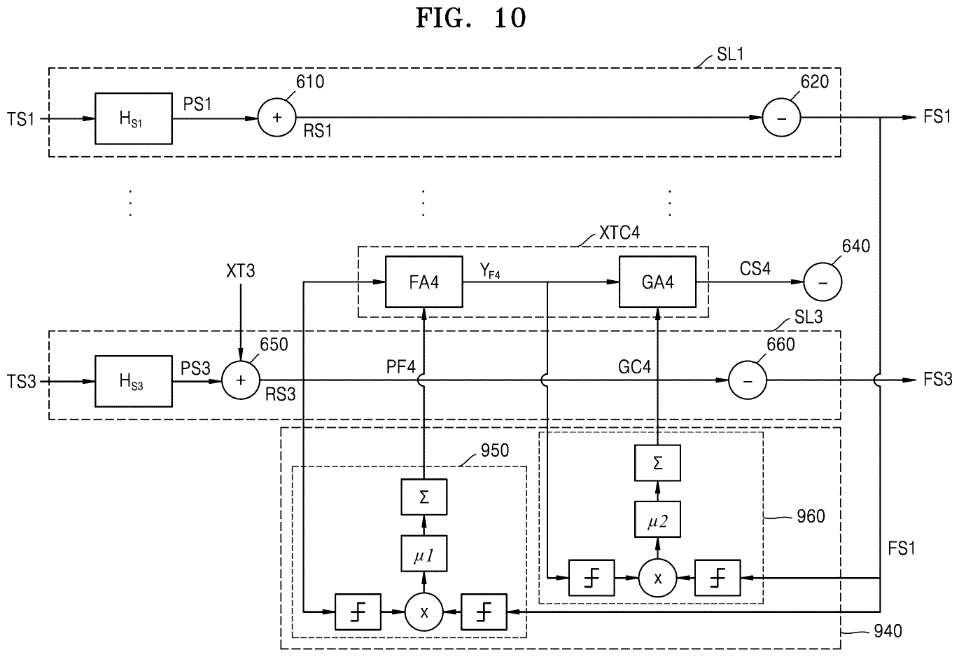

The electronic devices described herein may include an adaptive filter to adaptively adjust the XTC transfer function according to environmental changes, thereby improving the accuracy of crosstalk filtering. The adaptive filter will be described in more detail with reference to FIG. 10.

The foregoing may be better understood with reference to the first reception waveform SW5, which is the signal waveform of the first reception signal RS1, the second compensation waveform SW6, which is the signal waveform of the second compensation signal SC2, and the first final waveform SW7, which is the signal waveform of the first final signal FS1.

Referring to FIGS. 2 and 3A together, the second crosstalk waveform SW4 may be similar to the second compensation waveform SW6, and accordingly, the first final waveform SW7 may be similar to the first pass waveform SW3 in which crosstalk is not included. As the second XTC transfer function XTC2 is appropriately adjusted, the second crosstalk waveform SW4 and the second compensation waveform SW6 may be similar to each other. Referring to FIG. 3A, a first crosstalk filter may be included to remove distortion (e.g., distortion due to channel loss and crosstalk signal (XT1 in FIG. 2) included in the second reception signal RS2 described above with reference to FIG. 2.

Here, the first crosstalk filter may be expressed as a first XTC transfer function XTC1. The second signal line SL2 may include a second subtractor 320, and the second subtractor 320 may subtract the first compensation signal CS1 from the second reception signal RS2.

The first compensation signal CS1 may be a signal in which the first reception signal RS1 passes through the second crosstalk filter. The second subtractor 320 may subtract the first compensation signal CS1 from the second reception signal RS2 to output a second final signal FS2. When the second final signal FS2 is expressed by the transfer functions described above, it may be expressed by Equation 3 below.

$$FS 2 ( s ) = TS 2 ( s ) \cdot \{ {H}_{S 2} ( s ) - XTC 1 ( s ) \cdot {H}_{X T 2} ( s ) \} + TS 1 ( s ) \cdot \{ {H}_{XT 1} ( s ) - XTC 1 ( s ) \cdot {H}_{S 1} ( s ) \} \qquad [ Equation 3 ]$$

In Equation 3, when the condition such as Equation 4 below is satisfied, the influence of the first transmission signal TS1 may be removed from the second final signal FS2.

$${H}_{XT 1} ( s ) = XTC 1 ( s ) \cdot {H}_{S 1} ( s ) \qquad [ Equation 4 ]$$

In Equation 4, H_{XT1}(s) and H_{S1}(s) are transfer functions for coupling capacitance and channel loss, respectively, and thus, if the first XTC transfer function XTC1 is adjusted to satisfy Equation 1, the influence of the first transmission signal TS1 from the second final signal FS2 may be removed or alleviated.

That is, by adjusting the first XTC transfer function XTC1, the second final signal FS2 obtained by removing or alleviating crosstalk from the second reception signal RS2 is may be generated.

Referring to FIG. 3B, the first XTC transfer function XTC1 may include a first frequency adjustment circuit 330 and a first gain adjustment circuit 340. The description of FIG. 3A applies to FIG. 3B, and some description of the latter is omitted to avoid redundancy.

The second XTC transfer function XTC2 may include a second frequency adjustment circuit 350 and a second gain adjustment circuit 360. Referring to FIG. 3B, the adjustment of the first XTC transfer function XTC1 described above may refer to the adjustment of the first pole frequency of the first XTC transfer function XTC1 through the first frequency adjustment circuit 330 and the adjustment of the first gain coefficient of the first XTC transfer function XTC1 through the first gain adjustment circuit 340.

Similarly, the adjustment of the second XTC transfer function XTC2 may refer to the adjustment of the second pole frequency of the second XTC transfer function XTC2 through the second frequency adjustment circuit 350 and the adjustment of the second gain coefficient of the second XTC transfer function XTC2 through the second gain adjustment circuit 360. The first frequency adjustment circuit 330 may adjust the first pole frequency and output a first adjustment signal Y_{F1} to the first gain adjustment circuit 340 based on the adjusted first pole frequency.

Similarly, the second frequency adjustment circuit 350 may adjust the second pole frequency and output a second adjustment signal YF2 to the second gain adjustment circuit 360 based on the adjusted second pole frequency. As described above, adjustment of the pole frequency and adaptive adjustment of the gain coefficient to respond in real time to circuit characteristics caused by environmental changes may be performed through an adaptive filter to be described later.

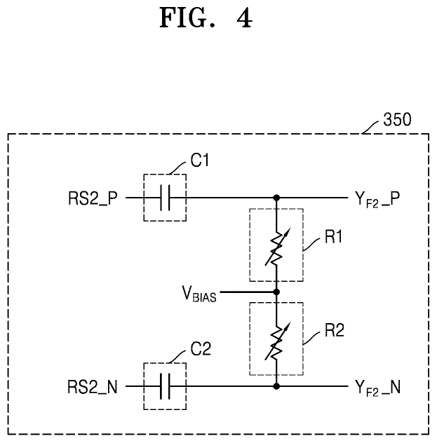

FIG. 4 is a circuit diagram illustrating an example of a frequency adjustment circuit. The frequency adjustment circuit of FIG. 4 can, for example, be used as the second frequency adjustment circuit 350 described above with reference to FIGS. 3A and 3B, and some following description will assume this configuration. However, this is only for convenience of explanation by describing, as an example reference, the removal of crosstalk by the second signal line SL2 with respect to the first signal line SL1 of FIG. 3A. Therefore, the first frequency adjustment circuit (330 in FIG. 3B) may be similarly understood with reference to the description of the frequency adjustment circuit of FIG. 4. That is, the first frequency adjustment circuit 330 can be the same as or similar to the frequency adjustment circuit shown in FIG. 4.

In addition, the frequency adjustment circuit is not limited to the circuit shown in FIG. 4, and may be implemented with various circuits that may adaptively adjust the pole frequency in response to changes in circuit characteristics due to environmental changes.

Referring to FIG. 4, the circuitry of the second frequency adjustment circuit 350 is for implementing a high-pass filter characteristic in the second XTC transfer function (XTC2 of FIG. 3A), and may include a first capacitor C1, a second capacitor C2, a first variable resistor R1, and a second variable resistor R2, which are passive elements.

Through this, high-pass filter characteristics may be implemented. In FIG. 4, the second reception signal RS2 of FIG. 3A may be implemented with two differential signals RS2_P and RS2_N, and similarly, the second adjustment signal Y_{F2} may be implemented with two differential signals Y_{F2}_P and Y_{F2}_N. In the high-pass filter characteristics, the waveform of the output signal (e.g., the above-described adjustment signal) may vary depending on the value of the pole frequency.

Therefore, the second XTC transfer function (XTC2 of FIG. 3A) may be implemented by adjusting the pole frequency. In this case, the pole frequency may be adjusted by adjusting a resistance value of each of the first variable resistor R1 and the second variable resistor R2. VBIAS may serve to maintain direct current components removed due to high-pass filter operation.

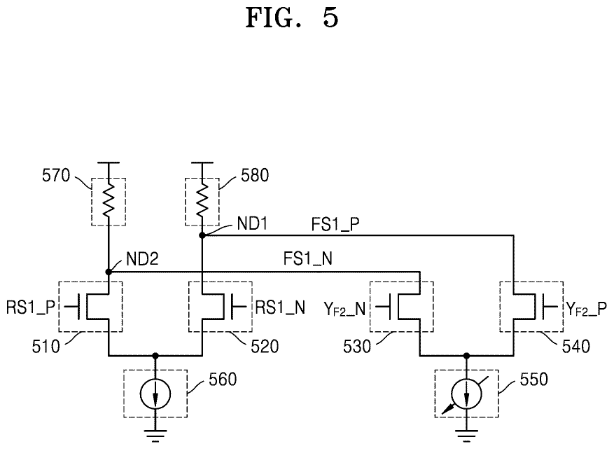

FIG. 5 is a circuit diagram illustrating a gain coefficient adjustment circuit and a subtractor. The circuitry of FIG. 5 can, for example, be used as the second gain adjustment circuit 360 in FIG. and the first subtractor 310 in FIG. 3B. This is only for convenience of explanation by describing, as an example reference, the removal of crosstalk by the second signal line SL2 of FIG. 3A with respect to the first signal line SL1 of FIG. 3A. Therefore, the first gain adjustment circuit (340 in FIG. 3B) and the second subtractor (320 in FIG. 3B) may be similarly understood with reference to the description of the gain adjustment circuit and the subtractor of FIG. 5. That is, the circuitry of FIG. 5 can be used for the first gain adjustment circuit 340 and the second subtractor 320.

In addition, the gain adjustment circuit and the subtractor is not limited to the circuit shown in FIG. 5, and may be implemented with various circuits that may adaptively adjust the gain coefficient in response to changes in circuit characteristics due to environmental changes.

Referring to FIG. 5, circuitry of a second gain adjustment circuit 360 of FIG. 3B and a first subtractor 310 of FIG. 3B may include a first transistor 510, a second transistor 520, a third transistor 530, a fourth transistor 540, a first current source 550, a second current source 560, a first resistor 570, and a second resistor 580.

The circuitry of the second gain adjustment circuit (360 in FIG. 3B) and the first subtractor (310 in FIG. 3B) illustrated in FIG. 5 may implement a signal gain in the second XTC transfer function (XTC2 in FIG. 3A), and may filter the crosstalk using the compensation signal (CS2 in FIG. 3B) generated through the second frequency adjustment circuit (350 in FIG. 4) and the second gain adjustment circuit (360 in FIG. 3B).

In FIG. 5, the first reception signal RS1 of FIG. 3A may be implemented with two differential signals RS1_P and RS1_N, and similarly, the second adjustment signal Y_{F2} of FIG. 3A may be implemented with two differential signals Y_{F2}_P and Y_{F2}_N.

The two differential signals RS1_P and RS1_N and the two differential signals Y_{F2}_P and Y_{F2}_N may be input to the second gain adjustment circuit 360 in FIG. 3B and the circuit of the first subtractor 310 in FIG. 3B. For example, each of the two differential signals RS1_P and RS1_N may be applied to a gate of each of the first transistor 510 and the second transistor 520. Similarly, each of the two differential signals Y_{F2}_P and Y_{F2}_N may be applied to a gate of each of the third transistor 530 and the fourth transistor 540. The first current source 550 may be a variable current source, and signal gain adjustment in the second XTC transfer function XTC2 of FIG. 3A may be implemented by adjusting the current flowing through the first current source 550. The second current source 560 may be a constant current source. A difference between the gain-adjusted second adjustment signal Y_{F2} of FIG. 3B and the first reception signal RS1 of FIG. 3B may be applied to a first node ND1 and a second node ND2. Accordingly, the crosstalk for the first signal line SL1 of FIG. 3B by the second signal line SL2 of FIG. 3B may be alleviated or removed. The first final signal FS1 of FIG. 3B may be implemented by two differential signals FS1_P and FS1_N, and the two differential signals FS1_P and FS1_N may be output through the first node ND1 and the second node ND2. The two differential signals FS1_P and FS1_N may be output while maintaining stability through the first resistor 570 and the second resistor 580.

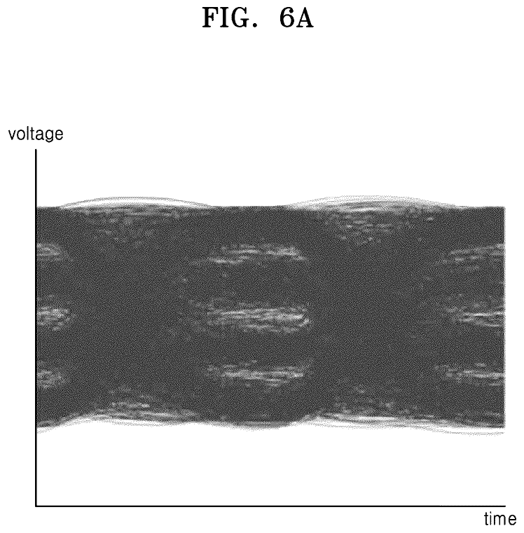

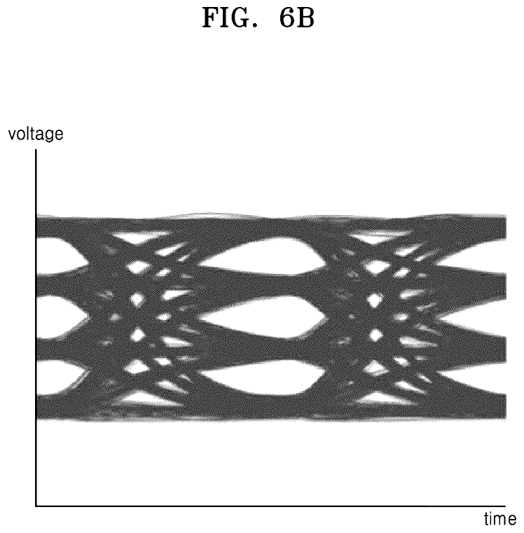

FIG. 6A is a diagram illustrating pulse-amplitude modulation (PAM)-4 Eye in a reception unit due to crosstalk, and FIG. 6B is a diagram illustrating PAM-4 Eye in the reception unit after filtering the crosstalk. FIGS. 6A and 6B represent eye diagrams of a signal generated by a PAM-4 scheme, that is, a PAM-4 signal. FIGS. 6A and 6B are graphs in which a voltage level of a PAM-4 signal is converted on a time basis. That is, the horizontal axis of each of the eye diagrams illustrated in FIGS. 6A and 6B indicates time, and the vertical axis thereof indicates a voltage. Waveform in which bits of data transmitted in series overlap may be similar to the shapes of the eyes, and the waveform may be referred to as an eye diagram.

The eye diagram may be used to indicate the quality of a signal received in high-speed transmission. For example, in PAM-4, an eye diagram may represent four symbols of the received signal (e.g., “00”, “01”, “10”, and “11”, and each of the four symbols may be represented by different first to fourth voltage levels. The eye diagram may be used to visually represent signal integrity and may represent the noise margin of the received signal. Eye diagrams may be used to identify a number of signal characteristics such as jitter, crosstalk, signal loss, signal-to-noise ratio (SNR), and other characteristics. For example, the larger the eye opening and eye width of the eye diagram, the better the characteristics of the signal. Here, the eye opening may be used to refer to the peak-to-peak voltage difference between the first to fourth voltage levels, and the eye width may be used to synchronize the timing of the received signal or to indicate the jitter effect of the received signal. The better the signal characteristic, the more accurately the received signal may be determined.

FIG. 6A is an eye diagram of a signal received by a reception unit when crosstalk is not filtered. FIG. 6B is an eye diagram of a signal received by a reception unit when crosstalk is filtered as described above. Comparing the eye diagrams illustrated in FIG. 6A and FIG. 6B, it may be seen that the eye opening and the eye width of the eye diagram illustrated in FIG. 6B are larger than those in FIG. 6A, indicating improved crosstalk removal.

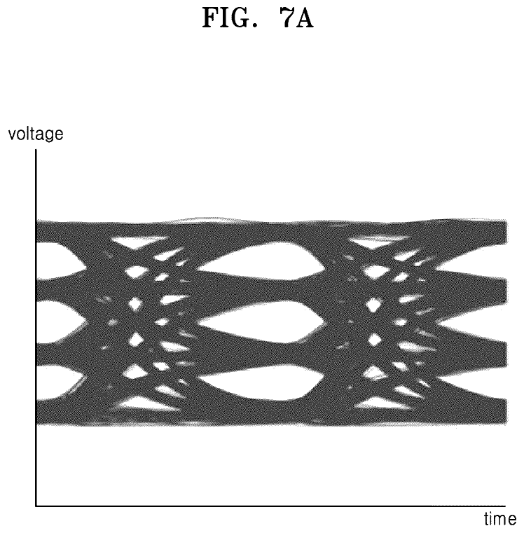

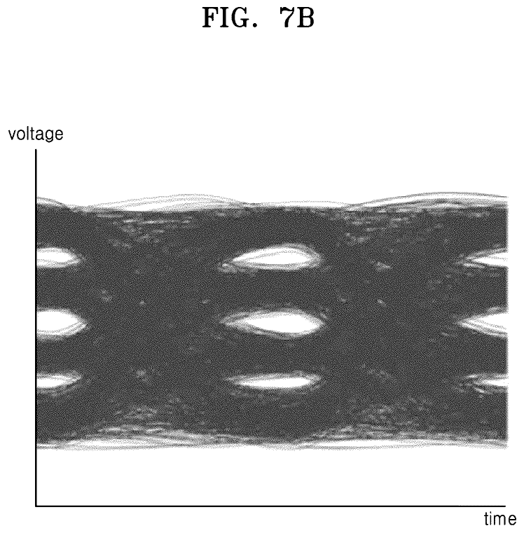

FIG. 7A is a diagram showing PAM-4 Eye in the reception unit after crosstalk filtering in a first environment (e.g., an eye diagram of a signal received by a reception unit when crosstalk is filtered in a first environment), and FIG. 7B is a diagram showing PAM-4 Eye in the reception unit after crosstalk filtering in a second environment (e.g., an eye diagram of a signal received by a reception unit when crosstalk is filtered in a second environment). FIGS. 7A and 7B may be understood in light of the foregoing description of FIGS. 6A and 6B.

In FIGS. 7A and 7B, the pole frequency and the gain coefficient of the XTC transfer function may be the same, and at least one of a process, a voltage, and a temperature may be different in the first environment and the second environment. As described above, even if the crosstalk is filtered based on the same pole frequency and gain coefficient, the received signal characteristics may be different according to changes in circuit characteristics according to environmental changes. That is, the accuracy of the crosstalk filtering may vary depending on process, voltage, temperature, and/or other conditions

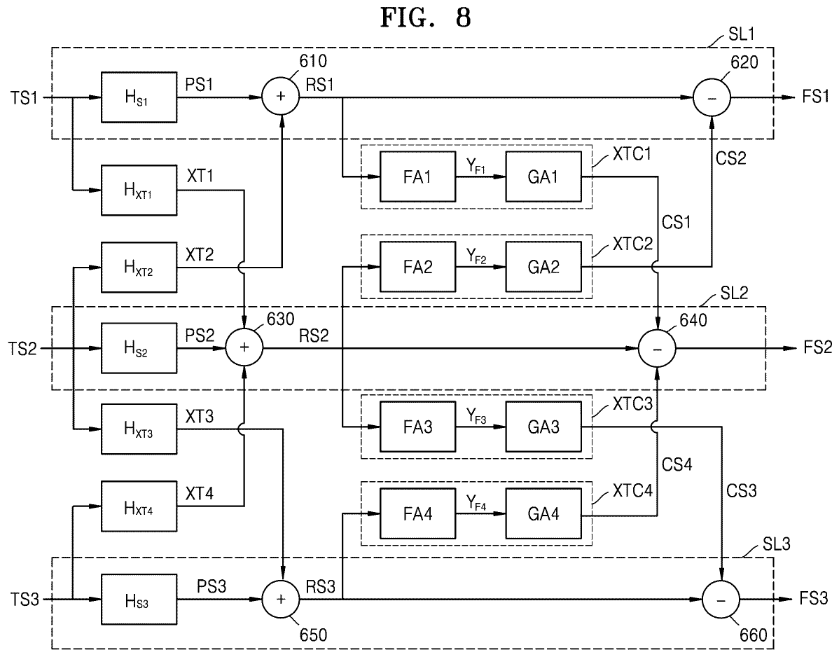

FIG. 8 is a diagram illustrating a plurality of signal lines and a plurality of crosstalk filters. FIG. 8 may be understood with reference to FIGS. 2 to 4 described above, and redundant description thereof may be omitted.

Referring to FIG. 8, a first transmission signal TS1, a second transmission signal TS2, and a third transmission signal TS3 may be transmitted from a transmission unit to a reception unit through a first signal line SL1, a second signal line SL2, and a third signal line SL3, respectively.

Referring to FIG. 8, the reception unit may receive a first reception signal RS1, a second reception signal RS2, and a third reception signal RS3, and may generate a first final signal FS1, a second final signal FS2, and a third final signal FS3 by performing crosstalk filtering on the first reception signal RS1, the second reception signal RS2, and the third reception signal RS3, respectively. Therefore, referring to FIG. 8, the reception unit may be understood as corresponding to components to the right of elements 610, 630, and 650.

The first pass signal PS1 may mean a distorted signal when the first transmission signal TS1 is transmitted through the first signal line SL1 between the transmission unit and the reception unit. Distortion caused by the first signal line SL1 may be expressed by a first channel transfer function H_{S1}. The reception unit may receive the first reception signal RS1 through the first signal line SL1.

The first reception signal RS1 may include the first pass signal PS1 and a second crosstalk signal XT2. The second crosstalk signal XT2 may mean noise due to coupling capacitance formed between the first signal line SL1 and the second signal line SL2. The reception unit may include a first subtractor 620.

For example, the first signal line SL1 included in the reception unit may include the first subtractor 620. The first subtractor 620 may generate a first final signal FS1 by subtracting a second compensation signal CS2 from the first reception signal RS1. The second compensation signal CS2 may be a signal in which the second reception signal RS2 is adjusted to be similar to the crosstalk by a second XTC transfer function XTC2. Accordingly, the reception unit may generate the first final signal FS1 by filtering the crosstalk included in the first reception signal RS1.

A description of the signals and the transmission functions transmitted from the transmission unit to the reception unit through the second signal line SL2 and the third signal line SL3 shown in FIG. 8 may be understood through the above description, and thus the description thereof is omitted.

As described above with reference to FIG. 8, the second compensation signal CS2 may be generated based on the second reception signal RS2 and the second XTC transfer function XTC2.

In this case, the second reception signal RS2 may include a second pass signal PS2, a first crosstalk signal XT1, and a fourth crosstalk signal XT4. Since the second reception signal RS2 includes the first crosstalk signal XT1, the second reception signal RS2 includes a component of the first transmission signal TS1. Therefore, the first transmission signal TS1 and the second transmission signal TS2 are correlated with each other. That is, the correlation between the first transmission signal TS1 (or the first reception signal RS1) and the second transmission signal TS2 (or the second reception signal RS2) is not zero (0). In the case of generating the first final signal FS1 with improved signal characteristics by removing crosstalk, the first transmission signal TS1 may be a signal source, and the second transmission signal TS2 may be a noise source. However, since the signal source and the noise source are correlated, the correlation is not zero (0).

In the structure of the reception unit, in some implementations, the adaptive filter may effectively operate by making the correlation between the signal source and the noise source close to 0.

For convenience of explanation, only the first signal line SL1, the second signal line SL2, and the third signal line SL3 are shown in FIG. 8, but the number of signal lines located between the transmission unit and the reception unit is not limited thereto. As described above, with technological development, two, three, or more signal lines may be included between the transmission unit and the reception unit for more data signal transmission/reception.

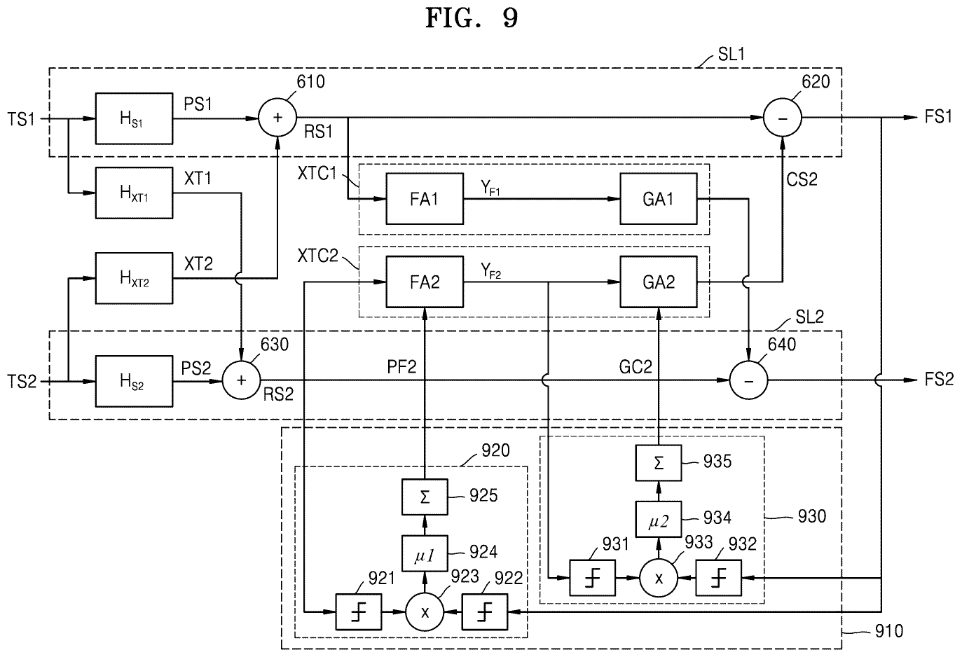

FIG. 9 is a diagram illustrating crosstalk filtering based on signals received through two consecutive signal lines. Description provided with respect to FIG. 8 can be applied to corresponding elements of FIG. 9 FIG. 9, and redundant descriptions thereof are omitted.

Referring to FIG. 9, the reception unit may include a first adaptive filter 910 connected to the second signal line SL2 to generate a first final signal FS1 obtained by filtering crosstalk from the first reception signal RS1. In the illustration of FIG. 9, the third signal line SL3 adjacent to the second signal line SL2 is omitted, but this is only omitted for convenience of description, and reception units according to the present disclosure are not limited thereto. It will be understood that further signal lines (e.g., SL3) can be included.

The first adaptive filter 910 may include a first adaptive loop 920 and a second adaptive loop 930. The first adaptive loop 920 may include a first comparator 921, a second comparator 922, a first multiplier 923, a first unit adjustment block 924 for applying a first adjustment unit μ1 to the output of the first multiplier 923, and a first accumulation block 925 for accumulating adjustment values. Similarly, the second adaptive loop 930 may include a third comparator 931, a fourth comparator 932, a second multiplier 933, a second unit adjustment block 934 for applying a second adjustment unit μ2 to the output of the second multiplier 933, and a second accumulation block 935 for accumulating adjustment values.

As shown in FIG. 9 and described above, since the operations and configurations of the first adaptive loop 920 and the second adaptive loop 930 are similar, such that the first adaptive loop 920 will be described below. With reference to this, the second adaptive loop 930 may be understood. Accordingly, the description of the operations of the components 931 to 935 included in the second adaptive loop 930 may be omitted.

The first comparator 921 included in the first adaptive loop 920 may receive the second reception signal RS2 and output the sign of the second reception signal RS2. The second comparator 922 included in the first adaptive loop 920 may receive the first final signal FS1 from the first subtractor 620 and output the sign of the first final signal FS1. The first multiplier 923 may receive the sign of the second reception signal RS2 and the sign of the first final signal FS1 from the first comparator 921 and the second comparator 922, respectively, and output a product (e.g., a first sign value) of the sign of the second reception signal RS2 and the sign of the first final signal FS1. The first unit adjustment block 924 may receive the first sign value and output an adjustment value by applying the first adjustment unit μ1 to the first sign value. The first accumulation block 925 may receive the adjustment value and accumulate the adjustment values received in the previous loop and the adjustment value received through the current loop. The first accumulation block 925 may output the accumulated adjustment value as the adjusted second pole frequency PF2. When the second pole frequency PF2, which is the output of the first adaptive loop 920 described above, is expressed in mathematical formula, it may be expressed as Equation 5 below.

$$PF 2 [ n + 1 ] = PF 2 [ n ] + μ 1 \cdot [ sign ( RS 2 ) \cdot sign ( FS 1 ) ] \qquad [ Equation 5 ]$$

In Equation 5, n means the number or index of loop repetitions.

Therefore, PF2[n+1] may be the second pole frequency PF2 in the current loop, and PF2[n] may be the second pole frequency PF2 in the previous loop. Each of the sign (RS2) and the sign (FS1) may mean a sign of the second reception signal RS2 and a sign of the first final signal FS1.

As described above, the first adaptive loop 920 may output the second pole frequency PF2 through the sign-sign least mean square (SSLMS) scheme according to Equation 5. This is only an example of the first adaptive loop 920, and other configurations are within the scope of this disclosure. For example, the first adaptive loop 920 may employ a least mean square (LMS) scheme or a receptive least square (RLS) scheme. For convenience of explanation, it is assumed that the pole frequency and gain coefficients are adaptively adjusted according to environmental changes through the SSLMS scheme described above. The second adaptive loop 930 may receive the second adjustment signal Y_{F2} and the first final signal FS2 to which the second pole frequency PF2 is applied.

Similar to the operation of the first adaptive loop 920 described above, the second adaptive loop 930 may generate a second gain coefficient GC2 adjusted based on the second adjustment signal Y_{F2} and the first final signal FS2, and the second adaptive loop 930 may output the second gain coefficient GC2. The reception unit may generate the second compensation signal CS2 by applying the second pole frequency PF2 and the second gain coefficient GC2 output from the first adaptive filter 910 to the second XTC transfer function.

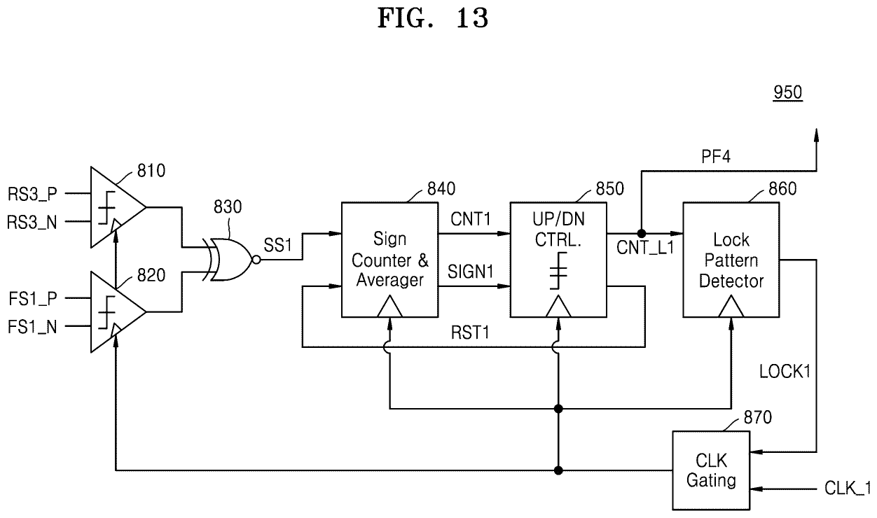

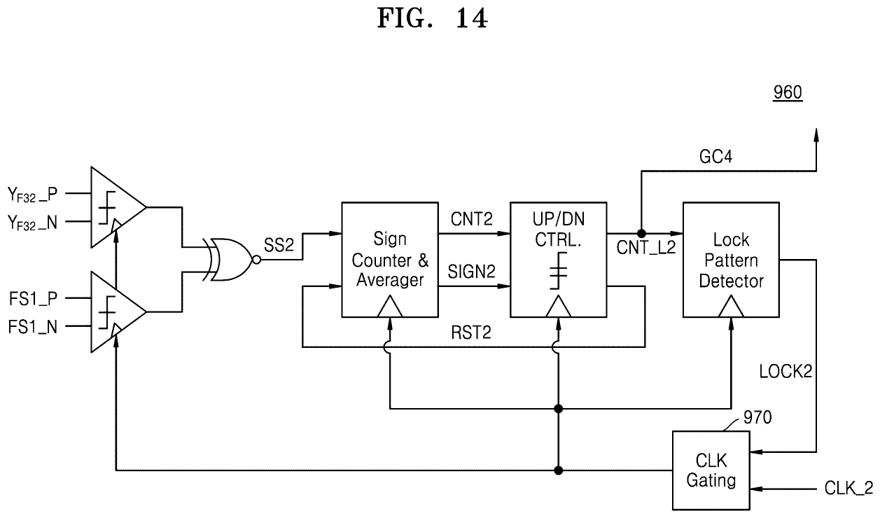

The reception unit may subtract the second compensation signal CS2 from the first reception signal RS1 to filter crosstalk due to coupling capacitance formed between the first signal line SL1 and the second signal line SL2 to generate the first final signal FS1. Based on the generated first final signal FS1, the operation described above may be repeated until the pole frequency and gain coefficient are stabilized. Stabilization of the pole frequency and the gain coefficient will be described in more detail with reference to FIGS. 13 and 14. Through the first adaptive filter 910, the reception unit may filter the crosstalk relatively accurately in response to changes in circuit characteristics according to environmental changes.

The configuration and operation of each of the first adaptive loop 920 and the second adaptive loop 930 will be described in more detail with reference to block diagrams illustrated in FIGS. 13 and 14, respectively. However, the block diagrams illustrated in FIGS. 13 and 14 are only examples for the first adaptive loop 920 and the second adaptive loop 930, and the loops 920, 930 are not limited thereto.

As described above, in some implementations, for the effective operation of the first adaptive filter 910, the correlation between the signal source and the noise source can be maintained close to zero. Since the first signal line SL1 and the second signal line SL2 are adjacent to each other, a correlation between the first transmission signal TS1 (or the first reception signal RS1) as a signal source and the second transmission signal TS2 (or the second reception signal RS2) as a noise source may not be close to 0 from the viewpoint of the first final signal FS1 due to coupling capacitance. Therefore, when the first adaptive filter 910 is connected to the first signal line SL1 and the second signal line SL2 as shown in FIG. 9, it may adaptively respond to changes in circuit characteristics due to environmental changes, but due to the correlation between two adjacent signal lines (e.g., SL1 and SL2), crosstalk filtering by the first adaptive filter 910 may be inaccurate.

FIG. 10 is a diagram illustrating crosstalk filtering based on signals received over two signal lines spaced apart from each other. FIG. 10 is described below following the above description with reference to FIG. 8, and FIG. 10 may be understood in comparison with FIG. 9. Description provided with respect to FIGS. 8 and 9 can be applied to FIG. 10, except where noted otherwise or suggested otherwise by context. Accordingly, redundant descriptions with reference to FIGS. 8 and 9 may be omitted hereinafter.

Referring to FIG. 10, the reception unit may include a second adaptive filter 940 connected to the third signal line SL3 to generate a first final signal FS1 obtained by filtering crosstalk from the first reception signal RS1.

That is, in FIG. 10, unlike in FIG. 9, the adaptive filter may be connected to the third signal line SL3. In addition, the second signal line SL2 adjacent to the first signal line SL1 is omitted for convenience of description. The configuration and operation of the second adaptive filter 940 may be the same as those of the first adaptive filter 910 of FIG. 9 described above with reference to FIG. 8.

A difference between the first adaptive filter 910 of FIG. 9 and the second adaptive filter 940 is that the first adaptive filter 910 of FIG. 9 is connected to the second signal line SL2 of FIG. 8, and the second adaptive filter 940 is connected to the third signal line. The second adaptive filter 940 may be connected to the third signal line SL3 whose correlation with the first signal line SL1 is close to 0 to generate the first final signal FS1. Since the second adaptive filter 940 is connected to the third signal line SL3, the second adaptive filter 940 may filter the crosstalk more accurately than the first adaptive filter 910 of FIG. 9. For example, the second adaptive filter 940 may more accurately filter the crosstalk included in the first reception signal RS1 by adjusting a fourth pole frequency PF4 and a fourth gain coefficient GC4 based on a third transmission signal TS3 whose correlation with the first transmission signal TS1 is close to 0. The correlation of the third reception signal RS3 and the first reception signal RS1 may be close to 0, e.g., may be less than the correlation of the second reception signal RS2 and the first reception signal RS1.

For example, the second adaptive filter 940 may receive the third reception signal RS3 and the first final signal FS1, and adjust and generate the fourth pole frequency PF4 and the fourth gain coefficient GC4 based on the third reception signal RS3 and the first final signal FS1. The third reception signal RS3, which is an input of the second adaptive filter 940, may include a component of the second reception signal RS2 of FIG. 7, but a component of the first transmission signal TS1 included in the third reception signal RS3 may be close to 0. As described above, the correlation between the first transmission signal TS1 (or the first reception signal RS1) and the third transmission signal TS3 (or the third reception signal RS3) may be close to zero, but since the noise source is the second transmission signal TS2 in FIG. 7 from the viewpoint of the first final signal FS1, filtering the crosstalk based on the third transmission signal TS3 may be inaccurate.

Accordingly, the second transmission signal TS2 and the third transmission signal TS3 may be correlated with each other. For example, the second transmission signal TS2 and the third transmission signal TS3 may have a same waveform. The second transmission signal TS2 and the third transmission signal TS3 may be differential signals having opposite phases to each other. For example, each of the second transmission signal TS2 and the third transmission signal TS3 may be a clock signal having a same waveform or a differential clock signal having opposite phases. A correlation between the second and third transmission signals TS2, TS3 may be greater than a correlation between the first transmission signal TS1 and the second transmission signal TS2, and greater than a correlation between the first transmission signal TS1 and the third transmission signal TS3. The reception unit may improve the accuracy of crosstalk filtering by using the third transmission signal TS3, which has a correlation close to zero (0) with the first transmission signal TS1 and has the same waveform as or opposite phase to the second transmission signal TS2, instead of the second transmission signal TS2, which is the noise source correlated with the first transmission signal TS1 (or where the second reception signal RS2 is correlated with the first reception signal RS1), which is the signal source, from the viewpoint of the first final signal FS1. Therefore, the reception unit may adaptively respond to changes in circuit characteristics according to environmental changes through adaptive filters, and in applying adaptive filters, signals with correlation close to zero (0) with the signal source may be used to improve the accuracy of crosstalk filtering.

Each of the third adaptive loop 950 and the fourth adaptive loop 960 will be described in more detail with reference to FIGS. 13 and 14. However, the block diagrams illustrated in FIGS. 13 and 14 are only examples for the third adaptive loop 950 and the fourth adaptive loop 960, and the loops 950, 960 are not limited thereto.

When the characteristics (e.g., spacing between signal lines, length of signal lines, conductivity of signal lines, etc.) of a plurality of signal lines are the same, the adjusted pole frequency and gain coefficient may be applied to a plurality of signal lines. That is, the adjusted pole frequency and gain coefficient may be applied for crosstalk filtering of a signal received through each of a plurality of signal lines. The plurality of signal lines may be distinct from the first, second, and third signal lines in reference to which the adjusted pole frequency and gain coefficient are determined.

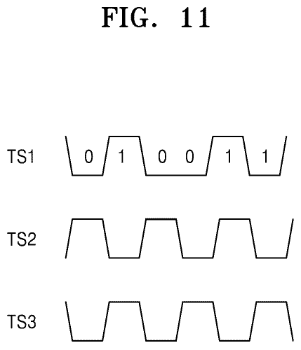

FIG. 11 is a diagram illustrating a first transmission signal, a second transmission signal, and a third transmission signal. FIG. 11 may be understood with reference to the above description provided for FIG. 10.

Referring to FIG. 11, as described above with reference to FIG. 10, the first transmission signal TS1 may be a data signal including data information expressed by “0” and “1”, and the second and third transmission signals TS2 and TS3 may be clock signals that operate in regular cycles.

The second transmission signal TS2 and the third transmission signal TS3 may be differential clock signals, as shown in FIG. 11. Since the transmission unit may transmit a clock signal for receiving a data signal together with the data signal to the reception unit by using the second transmission signal TS2 and the third transmission signal TS3 which are clock signals, in some implementations, the reception unit may not further include separate signal lines for receiving the second transmission signal TS2 and the third transmission signal TS3 correlated with each other.

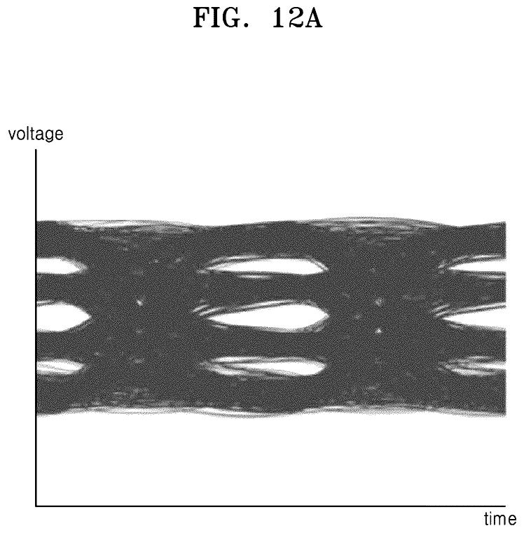

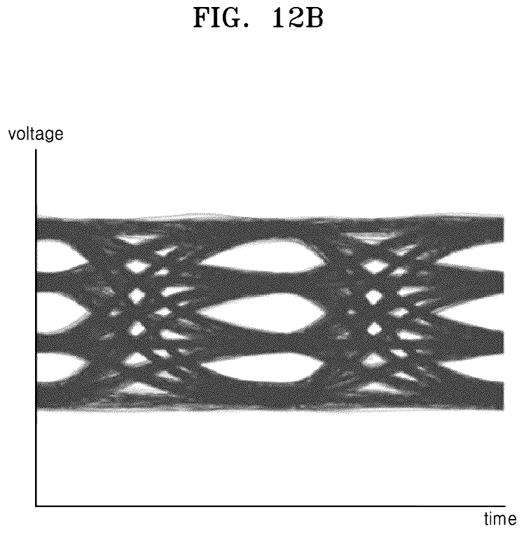

FIG. 12A is a diagram illustrating PAM-4 Eye in the reception unit after crosstalk filtering according to the block diagram illustrated in FIG. 9, and FIG. 12B is a diagram illustrating PAM-4 Eye in the reception unit after crosstalk filtering according to the block diagram illustrated in FIG. 10. FIGS. 12A and 12B may be understood with reference to FIGS. 6A to 7B described above.

It may be seen that the eye opening and the eye width of the eye diagram illustrated in FIG. 12B are greater than the eye opening and the eye width of the eye diagram illustrated in FIG. 12A. Therefore, as described above, the reception unit may more accurately determine the received signal by connecting the adaptive filter to a signal line that has a correlation close to zero (0) with the signal source and a high correlation with the noise source.

FIG. 13 is a diagram illustrating an example of a third adaptive loop shown in FIG. 10.

As described above, the first adaptive loop 920 illustrated in FIG. 9 is substantially the same as the third adaptive loop 950. However, there is a difference in that the first adaptive loop 920 in FIG. 9 is connected to the second signal line SL2 in FIG. 9, and the third adaptive loop 950 is connected to the third signal line SL3 in FIG. 10. Thus, although FIG. 13 illustrates the third adaptive loop, this is for convenience of explanation, and the operation of the first adaptive loop 920 in FIG. 9 may be understood through the block diagram illustrated in FIG. 13.

The third adaptive loop 950 may include a fifth comparator 810, a sixth comparator 820, a first XNOR gate 830, a first sign counter and an averaging block 840, a first up/down controller 850, a first lock pattern detection block 860, and a first clock gating block 870.

A plurality of components included in the third adaptive loop 950 are shown in FIG. 13 as mutually independent components, but this is for convenience of explanation, and two or more components included in the third adaptive loop 950 may be configured as one circuit. Accordingly, each of the first sign counter and averaging block 840, the first lock pattern detection block 860, and the first clock gating block 870 may be referred to as a first sign counter and averaging circuit 840, a first lock pattern detection circuit 860, and a first clock gating circuit 870.

Hereinafter, the second transmission signal (TS2 in FIG. 11) and the third transmission signal (TS3 in FIG. 11) will be described for cases in which they are differential clock signals with opposite phases as shown in FIG. 11. However, it will be understood that the following description is also applicable to implementations in which the second and third transmission signals have other forms.

The block diagram illustrated in FIG. 13 is a diagram for explaining the operation of the third adaptive loop 950 that generates the fourth pole frequency PF4 using the SSLMS scheme described above with reference to FIG. 9. Accordingly, the block diagram illustrated in FIG. 13 may be understood by referring to the foregoing description with reference to FIG. 9. In addition, as described above, the block diagram shown in FIG. 13 is applicable to various schemes including SSLMS, LMS, and RLS schemes.

As described above, the third adaptive loop 950 may receive the third reception signal RS3 of FIG. 10 and the first final signal FS1 of FIG. 10. The third reception signal RS3 of FIG. 10 may be expressed as two differential signals RS3_P and RS3_N, and the first final signal FS1 of FIG. 10 may be expressed as two differential signals FS1_P and FS1_N. Each of the fifth comparator 810 and the sixth comparator 820 may output the sign of the third reception signal RS3 of FIG. 10 and the sign of the first final signal FS1 of FIG. 10 to the first XNOR gate 830. The first XNOR gate 830 may multiply the sign of the third reception signal RS3 of FIG. 10 and the sign of the first final signal FS1 of FIG. 10 and invert the sign of the multiplied result and output the sign of the inverted result.

For example, the second transmission signal (TS2 in FIG. 11) and the third transmission signal (TS3 in FIG. 11) can be differential clock signals with opposite phases, and the first XNOR gate 830 can invert the sign of the third reception signal (RS3 in FIG. 10) so as to be similar to the second transmission signal (TS2 in FIG. 11), which is a noise source, and can multiply the sign of the inverted third reception signal (RS3 in FIG. 10) and the sign of the first final signal (FS1 in FIG. 10) to output a sign value SS1.

The SSLMS scheme reflecting the code inversion of the reception signal may be expressed by the following Equation 6.

$$PF 4 [ n + 1 ] = PF 4 [ n ] + μ 1 \cdot [ - sign ( RS 3 ) \cdot sign ( FS 1 ) ] \qquad [ Equation 6 ]$$

When Equation 6 is compared with Equation 5, there is a difference in that the signs of the reception signals (RS2 of Equation 5 and RS3 of Equation 6) are inverted.

The first sign counter and the averaging block 840 may receive the sign value SS1 from the first XNOR gate 830 and accumulate the received sign value SS1. The first sign counter and the averaging block 840 may apply a moving average to the accumulated sign value SS1 to minimize incorrect adjustment of the fourth pole frequency PF4 due to a determination error of the comparators 810 and 820 due to channel loss or the like. The first sign counter and the averaging block 840 may output the average accumulated sign value CNT1 and the average accumulated code SIGN1, which is a sign of the average accumulated sign value CNT1.

The first up/down controller 850 receives the average accumulation sign value CNT1 and the average accumulation code SIGN1, and when the average accumulation sign value CNT1 exceeds a predetermined threshold value, the fourth pole frequency PF4 may be adjusted in a direction of increasing or decreasing according to the average accumulation code SIGN1.

The first up/down controller 850 may output a first stabilization count CNT_L1 by counting the number of times the fourth pole frequency PF is adjusted within a predetermined threshold range.

After adjusting the fourth pole frequency PF4, the first up/down controller 850 may generate a reset signal RST1 to reset accumulation of the first sign counter and the averaging block 840. In addition, the first up/down controller 850 may determine the size of an adjustment unit.

In some implementations, since the stabilized fourth pole frequency PF4 only needs to be maintained after the fourth pole frequency PF4 is stabilized within a certain range, the reception unit may stop the operation of the third adaptive loop 950 to minimize power consumption.

The first lock pattern detection block 860 may detect whether the fourth pole frequency PF4 has been stabilized based on the first stabilization count CNT_L1. The first lock pattern detection block 860 may generate a first lock signal LOCK1 when stabilization of the fourth pole frequency PF4 is detected.

The first clock gating block 870 may receive the first lock signal LOCK1 and perform clock gating to stop the operation of the third adaptive loop 950, thereby minimizing power consumption.

Referring to FIG. 13, when the fourth pole frequency PF4 is stabilized, the operation of the third adaptive loop 950 is stopped to minimize power consumption, but operations within the scope of this disclosure are not limited thereto. The first lock pattern detection block 860 may detect whether the fourth pole frequency PF4 has been stabilized, and the reception unit may increase the period of the clock signal CLK1 input for the operation of the third adaptive loop 950 in response to the detection result. For example, the reception unit may increase a toggle period of the clock signal CLK1 input for the operation of the third adaptive loop 950 in response to stabilization of the fourth pole frequency PF4, thereby minimizing power consumption for the operation of the third adaptive loop 950 according to the toggle of the clock signal and the clock signal.

FIG. 14 is a diagram illustrating a fourth adaptive loop 960 as shown in FIG. 10. As described above, the second adaptive loop 930 illustrated in FIG. 9 is substantially the same as the fourth adaptive loop 960. However, there is a difference in that the second adaptive loop 930 in FIG. 9 is connected to the second signal line SL2 in FIG. 9, and the fourth adaptive loop 960 is connected to the third signal line SL3 in FIG. 10.

Thus, although FIG. 14 illustrates the fourth adaptive loop 960, this is for convenience of explanation, and the operation of the first adaptive loop 920 in FIG. 9 may be understood through the block diagram illustrated in FIG. 14. In addition, it may be easily understood that the fourth adaptive loop 960 shown in FIG. 14 is substantially the same as the third adaptive loop (950 in FIG. 13) described above with reference to FIG. 13.

However, in some implementations, each of the fourth adaptive loop 960 and the third adaptive loop (950 in FIG. 13) has a difference in the adjustment unit, the input signal (e.g., Y_{F2}), and the output according to the input signal (e.g., the fourth gain coefficient GC4).

In addition, the descriptions of the blocks, the sign value SS2, the average accumulation sign value CNT2, the average accumulation sign value SIGN2 which is a sign of the average accumulation sign value CNT2, the reset signal RST2, the second stabilization count CNT_L2, the second lock signal LOCK2, and the clock signal CLK2, which are shown in FIG. 14, are omitted because they may be understood through FIGS. 13 and 14, and the those described above. That is, the description provided for these elements is equally applicable to the corresponding elements of FIG. 14.

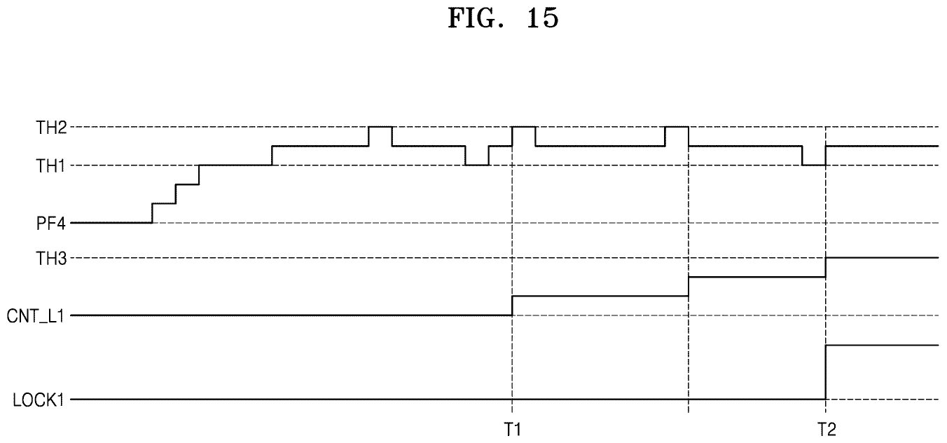

FIG. 15 is a timing diagram of signals associated with clock gating. As described above with reference to FIGS. 13 and 14, the adaptive loop may reduce power consumption through clock gating when the output (e.g., gain coefficient) is stabilized.

Referring to FIG. 15 in conjunction with FIGS. 13 and 14, when the fourth pole frequency PF4 is adjusted by a predetermined number of times TH3 or more within a predetermined threshold range (between TH1 and TH2), the reception unit may generate the first lock signal LOCK1 at a time point T2 based on the first stabilization count CNT_L1.

For example, the first stabilization count CNT_L1 may be increased whenever the fourth pole frequency PF4 is adjusted from a time point (e.g., T1) when the fourth pole frequency PF4 is adjusted more than five times within a predetermined threshold range (between TH1 and TH2).

When the first stabilization count CNT_L1 is adjusted by a predetermined number of times TH3 or more in a predetermined threshold range (between TH1 and TH2), the reception unit may generate a first lock signal LOCK1.

The reception unit may perform clock gating based on the first lock signal LOCK1. In some implementations, the reception unit may increase the toggle period of the clock signal based on the first lock signal LOCK1. The timing diagram illustrated in FIG. 15 is an example for describing clock gating, and implementations within the scope of this disclosure are not limited thereto. Accordingly, the predetermined threshold range and the predetermined number of adjustments may be defined differently in various implementations.

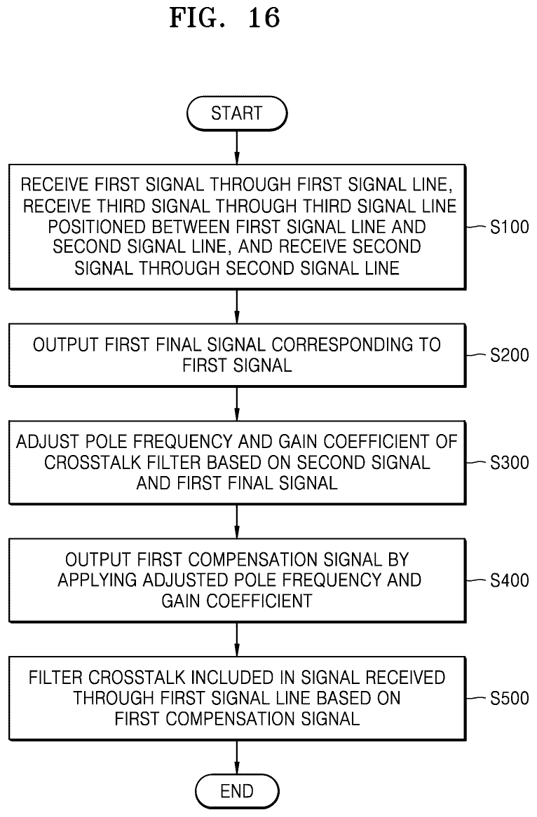

FIG. 16 is a flowchart illustrating an operating method of an electronic device, e.g., the devise described above. Accordingly, FIG. 16 may be understood through the above description, and the above description may be supplemented through FIG. 16.

Referring to FIG. 16, in operation S100, the electronic device may receive a first signal through a first signal line, a third signal through a third signal line positioned between the first signal line and the second signal line, and a second signal through the second signal line. As described above, the first signal line, the second signal line, and the third signal line may be adjacent.

In addition, the first signal may be a data signal including data information, and the second signal and the third signal may be a clock signal having a correlation.

For example, the second signal and the third signal may be signals corresponding to differential clock signals with opposite phases. For example, the second signal and the third signal may be signals corresponding to the differential clock signal transmitted by the transmission unit.

In operation S200, the electronic device may output a first final signal corresponding to the first signal. In operation S300, the electronic device may adjust the pole frequency and gain coefficient of the crosstalk filter based on the second signal and the first final signal.

The electronic device may adjust the pole frequency based on the second signal and the first final signal, and adjust the gain coefficient based on the adjustment signal to which the adjusted pole frequency has been applied and the first final signal.

As described above, the electronic device may adjust the pole frequency and gain coefficient according to a SSLMS scheme or another suitable scheme.

In operation S400, the electronic device may output a first compensation signal by applying the adjusted pole frequency and gain coefficient.

In operation S500, the electronic device may filter the crosstalk included in the signal received through the first signal line based on the first compensation signal.

The electronic device may determine the pole frequency as a final pole frequency when the pole frequency is adjusted a predetermined first number of times or more within a predetermined first threshold range. In addition, the electronic device may determine the gain coefficient as a final gain coefficient when the gain coefficient is adjusted a predetermined second number of times or more within a predetermined second threshold range.

The electronic device may generate a first lock signal for stopping adjustment of the pole frequency in response to determination of the final pole frequency, and the electronic device may generate a second lock signal for stopping adjustment of the gain coefficient in response to determination of the final gain coefficient.

The electronic device may reduce power consumption by increasing a toggle period of the first clock signal for adjusting the pole frequency in response to determination of the final pole frequency.

Similarly, the electronic device may reduce power consumption by increasing a toggle period of the second clock signal for adjusting the gain coefficient in response to the determination of the final gain coefficient.

The final pole frequency and the final gain coefficient determined as described above may be applied to each of the plurality of crosstalk filters corresponding to each of the plurality of signal lines to thereby filter the crosstalk included in the signal received through the plurality of signal lines.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While certain examples have been particularly shown and described, it will be understood that various changes in form and details may be made therein without departing from the spirit and scope of this disclosure.

What is claimed is:

1. An electronic device comprising:
a first signal line configured to transfer a first transmission signal output from a transmission unit;
a second signal line configured to transfer a second transmission signal output from the transmission unit;
a third signal line configured to transfer a third transmission signal, wherein the third transmission signal is output from the transmission unit, and wherein the third signal line is positioned between the first signal line and the second signal line;
a first crosstalk filter connected to the second signal line and configured to output a first compensation signal by applying filtering based on a pole frequency and by applying gain based on a gain coefficient, to a second reception signal corresponding to the second transmission signal;
an adaptive filter connected to the second signal line and configured to receive the second reception signal and a first final signal corresponding to the first transmission signal,
wherein the adaptive filter is configured to adjust the pole frequency and the gain coefficient of the first crosstalk filter based on the second reception signal and the first final signal; and
a subtractor circuit configured to filter crosstalk included in the first final signal by subtracting the first compensation signal from the first final signal.

2. The electronic device of claim 1, wherein:
the second transmission signal and the third transmission signal are a same clock signal, or
the second transmission signal and the third transmission signal are differential clock signals with opposite phases.

3. The electronic device of claim 2, wherein the first transmission signal is a data signal including data information.

4. The electronic device of claim 1, wherein the first, second, and third signal lines are arranged such that a correlation between the second reception signal and a first reception signal, corresponding to the first transmission signal, is less than a correlation between a third reception signal, corresponding to the third transmission signal, and the first reception signal.

5. The electronic device of claim 1, wherein the first signal line and the third signal line are directly adjacent, and the third signal line and the second signal line are directly adjacent.

6. The electronic device of claim 1, wherein the adaptive filter comprises a first adaptive loop and a second adaptive loop,
wherein the first adaptive loop is configured to receive the second reception signal and the first final signal, and to adjust the pole frequency based on the second reception signal and the first final signal, and
wherein the second adaptive loop is configured to receive an adjustment signal to which the adjusted pole frequency is applied and the first final signal, and to adjust the gain coefficient based on the adjustment signal and the first final signal.

7. The electronic device of claim 6, wherein each of the first adaptive loop and the second adaptive loop is configured to adjust the pole frequency and the gain coefficient according to a sign-sign least mean square (SSLMS) scheme.

8. The electronic device of claim 6, wherein the first adaptive loop comprises a first lock pattern detection circuit configured to detect whether the pole frequency is stabilized; and
wherein the first lock pattern detection circuit is configured to generate a first lock signal to stop operation of the first adaptive loop, based on the pole frequency being adjusted at least predetermined number of times within a predetermined range.

9. The electronic device of claim 8, wherein the adaptive filter is configured to determine a stabilized pole frequency, and wherein the electronic device further comprises:
a plurality of signal lines distinct from the first, second, and third signal lines; and
a plurality of crosstalk filters respectively connected to the plurality of signal lines, wherein each crosstalk filter of the plurality of crosstalk filters is configured to apply filtering based on the stabilized pole frequency.

10. The electronic device of claim 6, wherein the second adaptive loop comprises a second lock pattern detection circuit configured to detect whether the gain coefficient is stabilized, and
wherein the second lock pattern detection circuit is configured to generate a second lock signal to stop operation of the second adaptive loop, based on the gain coefficient being adjusted a predetermined number of times or greater within a predetermined range.

11. The electronic device of claim 10, wherein the adaptive filter is configured to determine a stabilized gain coefficient, and wherein the electronic device further comprises:
a plurality of signal lines distinct from the first, second, and third signal lines; and
a plurality of crosstalk filters respectively connected to the plurality of signal lines, wherein each crosstalk filter of the plurality of crosstalk filters is configured to apply gain based on the stabilized gain coefficient.

12. An operating method of an electronic device, the operating method comprising:
receiving a first signal via a first signal line, receiving a third signal via a third signal line located between the first signal line and a second signal line, and receiving a second signal via the second signal line;
outputting a first final signal corresponding to the first signal;
adjusting a pole frequency and a gain coefficient based on the second signal and the first final signal, to obtain an adjusted pole frequency and an adjusted gain coefficient;
outputting a first compensation signal by applying (i) filtering based on the adjusted pole frequency and (ii) gain based on the adjusted gain coefficient, to the second signal; and
filtering crosstalk included in a signal received through the first signal line based on the first compensation signal,
wherein the first signal line and the third signal line are directly adjacent, the third signal line and the second signal line are directly adjacent, the first signal is a data signal including data information, and the second signal and the third signal are clock signals having a correlation with one another.

13. The operating method of claim 12, wherein the second signal and the third signal are based on differential clock signals with opposite phases.

14. The operating method of claim 12, wherein adjusting the pole frequency and the gain coefficient comprises:
adjusting the pole frequency based on the second signal and the first final signal; and
adjusting the gain coefficient based on (i) an adjustment signal to which filtering based on the adjusted pole frequency is applied and (ii) the first final signal.

15. The operating method of claim 14, wherein adjusting the pole frequency and adjusting the gain coefficient are based on a sign-sign least mean square (SSLMS) scheme.

16. The operating method of claim 14, further comprising:
determining the pole frequency as a final pole frequency based on the pole frequency being adjusted at least a predetermined first number of times within a predetermined first range; and
determining the gain coefficient as a final gain coefficient based on the gain coefficient being adjusted at least a predetermined second number of times within a predetermined second range.

17. The operating method of claim 16, further comprising:
generating a first lock signal to stop the adjustment of the pole frequency in response to the determination of the final pole frequency; and
generating a second lock signal to stop the adjustment of the gain coefficient in response to the determination of the final gain coefficient.

18. The operating method of claim 16, further comprising:
increasing a toggle period of a first clock signal for adjustment of the pole frequency, in response to the determination of the final pole frequency; and
increasing a toggle period of a second clock signal for adjusting the gain coefficient, in response to the determination of the final gain coefficient.

19. The operating method of claim 16, further comprising:
filtering crosstalk included in signals received through a plurality of signal lines by applying (i) filtering based on the final pole frequency and (ii) gain based on the final gain coefficient, in each of a plurality of crosstalk filters respectively corresponding to the plurality of signal lines,
wherein the plurality of signal lines are distinct from the first, second, and third signal lines.

20. An electronic device comprising:
a plurality of signal lines that are consecutive to each other;
a plurality of crosstalk filters configured to compensate for crosstalk between the plurality of signal lines by applying filtering based on a pole frequency and gain based on a gain coefficient to signals received over the plurality of signal lines; and
an adaptive filter configured to adjust the pole frequency and the gain coefficient of each of the plurality of crosstalk filters, wherein the plurality of signal lines comprise:
a first signal line configured to transfer a data signal including data information;
a second signal line located between the first signal line and a third signal line and configured to transfer a first clock signal; and
the third signal line, wherein the third signal line is configured to transfer a second clock signal that is opposite in phase to the first clock signal,
wherein the adaptive filter is connected to the third signal line, and
wherein the adaptive filter is configured to adjust the pole frequency based on a final signal generated by filtering crosstalk from the second clock signal and the data signal, and to adjust the gain coefficient based on (i) an adjustment signal to which filtering based on the adjusted pole frequency is applied and (ii) the final signal.
